(19) United States
(12) Patent Application Publication
(10) Pub. No.: US 2023/0312134 A1
(43) Pub. Date: Oct. 5, 2023

(54) POWER SUPPLY APPARATUS AND POWER SUPPLY MANAGEMENT SYSTEM

(71) Applicant: HONDA MOTOR CO., LTD., Tokyo (JP)

(72) Inventor: Junichiro Kano, Wako-shi (JP)

(21) Appl. No.: 18/178,650

(22) Filed: Mar. 6, 2023

(30) Foreign Application Priority Data
Mar. 30, 2022 (JP) 2022-055434

(51) Int. Cl. B64F 1/22; B64C 29/00; B64F 1/36; B64D 27/24; H02J 7/00

(52) U.S. Cl. CPC B64F 1/22; B64C 29/0008; B64F 1/36; B64D 27/24; H02J 7/0063; H02J 2310/44

(57) ABSTRACT

A power supply apparatus includes: a traveling unit operated and caused to travel by electric power supplied from a first storage battery; a pad on which a vertical take-off and landing aircraft is placed; a power supply unit for supplying the aircraft with power output from the first storage battery; a movement plan recognition unit for recognizing a movement plan of the aircraft; a second storage battery state recognition unit for recognizing a state of a second storage battery provided in the aircraft; and a power supply control unit for controlling first power, which is supplied from the first storage battery to the traveling unit based on the movement plan and the state of the second storage battery, and second power, which is supplied from the first storage battery to the aircraft via the power supply unit.

### INCORPORATION BY REFERENCE

The present application claims priority under 35 U.S.C. § 119 to Japanese Patent Application No. 2022-055434 filed on Mar. 30, 2022. The content of the application is incorporated herein by reference in its entirety.

### BACKGROUND OF THE INVENTION

### Field of the Invention

The present invention relates to a power supply apparatus and a power supply management system.

### Description of the Related Art

Conventionally, there has been proposed a system for a vertical take-off and landing aircraft which determines a robotic charging device for charging an aircraft from among a plurality of robotic charging devices for charging aircrafts, based on transportation itinerary data and energy parameters (see, for example, U.S. Patent Application Publication No. 2021/0284357). The system further determines charging parameters based on the transportation itinerary data and instructs the robotic charging device to charge the aircraft.

The robotic charging device operated by the above system is connected to the aircraft parked at the predetermined departure and arrival port or boarding and alighting area to charge the aircraft. Therefore, when the aircraft moves between the departure and arrival port and the boarding and alighting area, it is necessary to disconnect and reconnect the robotic charging device and the aircraft, which is inefficient. In addition, because aircraft charging is interrupted while the aircraft is moving, there is room for improvement in more efficiently using the time when the aircraft is waiting on the ground for power supply to the aircraft.

An object of the present invention, which has been made in view of such a background, is to provide a power supply apparatus and a power supply management system capable of efficiently supplying power to a flying object moving between a plurality of areas while waiting on ground.

### SUMMARY OF THE INVENTION

A first aspect for achieving the above object is a power supply apparatus including: a first storage battery; a traveling unit operated and caused to travel by electric power supplied from the first storage battery; a pad, mounted on the traveling unit, on which a vertical take-off and landing aircraft is placed; a power supply unit for supplying the aircraft placed on the pad with power output from the first storage battery; a movement plan recognition unit for recognizing a movement plan of the aircraft; a second storage battery state recognition unit for recognizing a state of a second storage battery provided in the aircraft; and a power supply control unit for controlling first power and second power via the power supply unit, based on the movement plan recognized by the movement plan recognition unit and the state of the second storage battery recognized by the second storage battery state recognition unit, the first power being supplied from the first storage battery to the traveling unit, the second power being supplied from the first storage battery to the aircraft via the power supply unit.

The above power supply apparatus may be configured such that the power supply control unit determines a supply amount of the first power, based on power required for moving by using the traveling unit while the aircraft is placed on the pad, between predetermined points by a time of next flight of the aircraft.

The above power supply apparatus may be configured such that the power supply control unit determines a supply amount of the second power, based on power required for charging a second storage battery and power required for operating a storage battery temperature adjustment unit, the second storage battery being provided in the aircraft, the storage battery temperature adjustment unit being provided in the aircraft, the storage battery temperature adjustment unit heating or cooling the second storage battery.

The above power supply apparatus may be configured such that the movement plan includes a departure time, a departure location, an arrival time, an arrival location, and movement points on ground.

A second aspect for achieving the above object is a power supply management system for managing operation of a power supply apparatus including: a first storage battery; a traveling unit operated and caused to travel by electric power supplied from the first storage battery; a pad, mounted on the traveling unit, on which a vertical take-off and landing aircraft is placed; and a power supply unit for supplying the aircraft placed on the pad with power output from the first storage battery, the power supply management system including: a first storage battery state recognition unit that individually recognizes states of the first storage batteries for a plurality of the power supply apparatuses; a movement plan recognition unit for recognizing a movement plan of a target aircraft, the target aircraft being the aircraft parked at a first point; a second storage battery state recognition unit for recognizing a state of a second storage battery provided in the target aircraft; and a power supply apparatus selection unit for selecting the power supply apparatus that is to travel to a second point while the target aircraft is placed on the pad, based on: states of the first storage batteries of a plurality of the power supply apparatuses; the movement plan being recognized by the movement plan recognition unit; and a state of the second storage battery, the states of the first storage batteries being recognized by the first storage battery state recognition unit, the state of the second storage battery being recognized by the second storage battery state recognition unit.

The above power supply apparatus and power supply management system makes it possible to efficiently supply power to a flying object that moves between a plurality of areas while waiting on the ground.

### BRIEF DESCRIPTION OF THE DRAWINGS

FIG. 1 is a configuration diagram of a power supply apparatus;

FIG. 2 is an explanatory diagram of an aspect of a power supply management system managing power supply to an aircraft;

FIG. 3 is a configuration diagram of the power supply management system; and

FIG. 4 is a flowchart of the power supply management system selecting a power supply apparatus;

FIG. 5 is a flowchart of the power supply apparatus controlling power supply.

### DETAILED DESCRIPTION OF THE PREFERRED EMBODIMENTS

### [1. Configuration of Power Supply Apparatus]

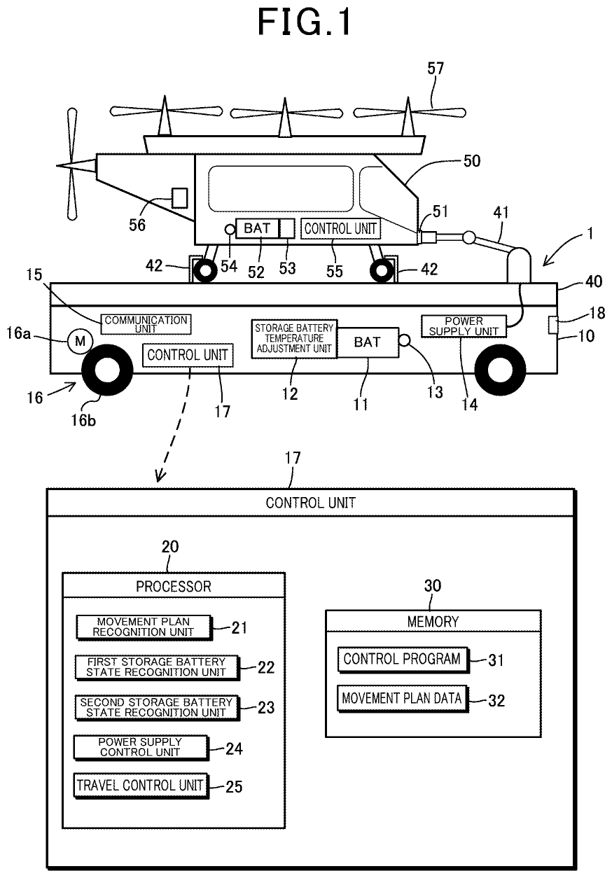

A configuration of a power supply apparatus 1 according to the present embodiment will be described with reference to FIG. 1. The power supply apparatus 1 includes a truck unit 10 and a pad 40 mounted on the truck unit 10. The pad 40: has a vertical take-off and landing type aircraft 50 such as a VTOL aircraft (Vertical Take-Off and Landing aircraft) placed thereon; and includes fixtures 42 for fixing an aircraft 50, a power supply arm 41 to be connected to a charging port 51 of the aircraft 50 to supply power to the aircraft 50. Further, the power supply apparatus 1 may have a function for placing the aircraft 50 on the pad 40.

The aircraft 50 includes: a second storage battery 52 that is a drive source for a rotor 57 and the like; a storage battery temperature adjustment unit 53 that heats or cools the second storage battery 52 to maintain the temperature of the second storage battery 52 within an appropriate temperature range; a storage battery sensor 54 that detects the state (voltage, current, temperature, etc.) of the second storage battery 52; a control unit 55; and a communication unit 56.

The second storage battery 52 is charged with power supplied from the charging port 51. The storage battery temperature adjustment unit 53 operates by power supplied from the second storage battery 52 or power supplied from the charging port 51. The aircraft 50 may be an electric aircraft using only the second storage battery 52 as a power source, or may be a hybrid aircraft equipped with a generator operated by a gas turbine or the like in addition to the second storage battery 52. If the aircraft 50 is of hybrid, the configuration may be such that the second storage battery 52 can be charged with the power generated by the generator.

The truck unit 10 of the power supply apparatus 1 includes a first storage battery 11; a storage battery temperature adjustment unit 12 that heats or cools the first storage battery 11 to maintain the temperature of the first storage battery 11 within an appropriate temperature range; a storage battery sensor 13 that detects the state (voltage, current, temperature, etc.) of the first storage battery 11; a power supply unit 14 that supplies power output from the first storage battery 11 to the aircraft 50 via the power supply arm 41; a communication unit 15 (transmitter and receiver); a traveling unit 16; and a control unit 17. The first storage battery 11 is charged by a charging device connected to a charging port 18.

The traveling unit 16 includes an electric motor 16a operated by power supplied from the first storage battery 11, a drive wheel 16b driven by the electric motor 16a, a frame of the truck unit 10 and the like, causing the power supply apparatus 1 to travel. The power supply apparatus 1 may be operated by a driver or may travel automatically. When the power supply apparatus 1 automatically travels, it travels while recognizing the surroundings of the power supply apparatus 1 using a camera, radar, or the like (not shown).

The control unit 17 is comprised with a computer including a processor 20, a memory 30 or the like. The memory 30 stores a control program 31 for the power supply apparatus 1 and movement plan data 32 in which movement plan information indicating a movement plan for the aircraft 50 is recorded. The movement plan includes plans of the aircraft 50 such as the next departure location, departure time, arrival location, arrival time, and travel schedule between areas during waiting.

By reading and executing the control program 31, the processor 20 functions as a movement plan recognition unit 21, a first storage battery state recognition unit 22, a second storage battery state recognition unit 23, a power supply control unit 24, and a travel control unit 25. The movement plan recognition unit 21 accesses an aircraft DB (database) 211 to be described later, acquires the movement plan information MVP of the aircraft 50, and records the acquired movement plan information MVP32 in the movement plan data 32.

The first storage battery state recognition unit 22 recognizes a state of the first storage battery 11 (electricity storage amount, temperature, etc.) based on the detection information of the storage battery sensor 13, and transmits first storage battery state information BC1 indicating the state of the first storage battery 11 to a power supply management system 100, which will be described later. The second storage battery state recognition unit 23 receives the second storage battery state information BC2 transmitted from the aircraft 50, and recognizes the state (electricity storage amount, temperature, etc.) of the second storage battery 52 from the second storage battery state information BC2. Based on the movement plan of the aircraft 50 and the state of the second storage battery 52, the power supply control unit 24: charges the second storage battery 52 as much as needed for the flight of the aircraft 50 according to the movement plan of the aircraft 50; and controls the power amount of a second power to be supplied to the aircraft 50 to enable the storage battery temperature adjustment unit 53 to sufficiently operate during waiting on the ground of the aircraft 50.

Further, the power supply control unit 24 controls the power amount of a first power to be supplied to the traveling unit 16, based on the movement plan of the aircraft 50, in traveling with the placed aircraft 50. The travel control unit 25 operates the traveling unit 16 with the first power controlled by the power supply control unit 24 to cause the power supply apparatus 1 to travel.

### [2. Configuration of Power Supply Management System]

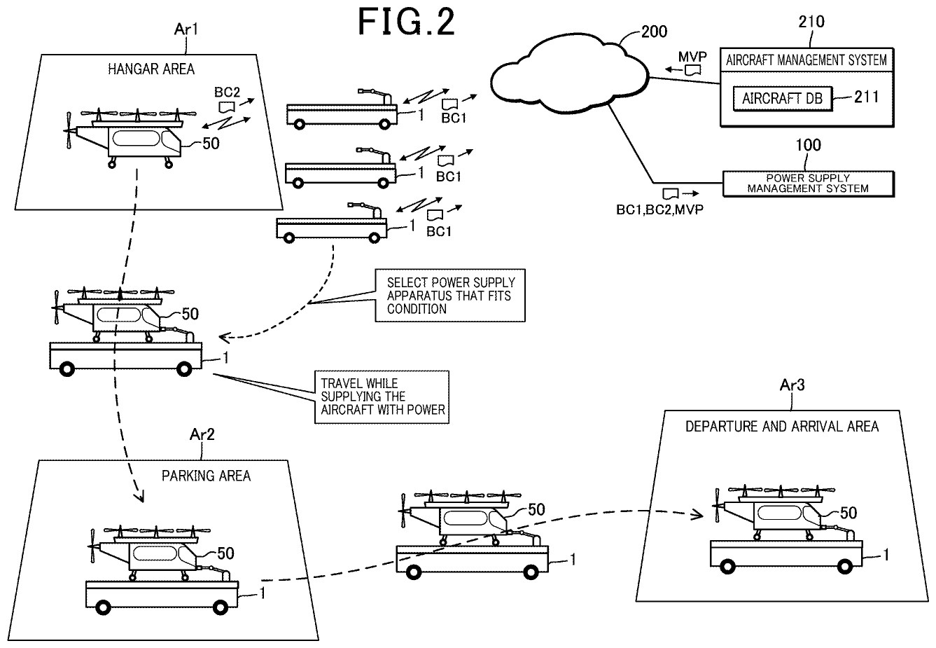

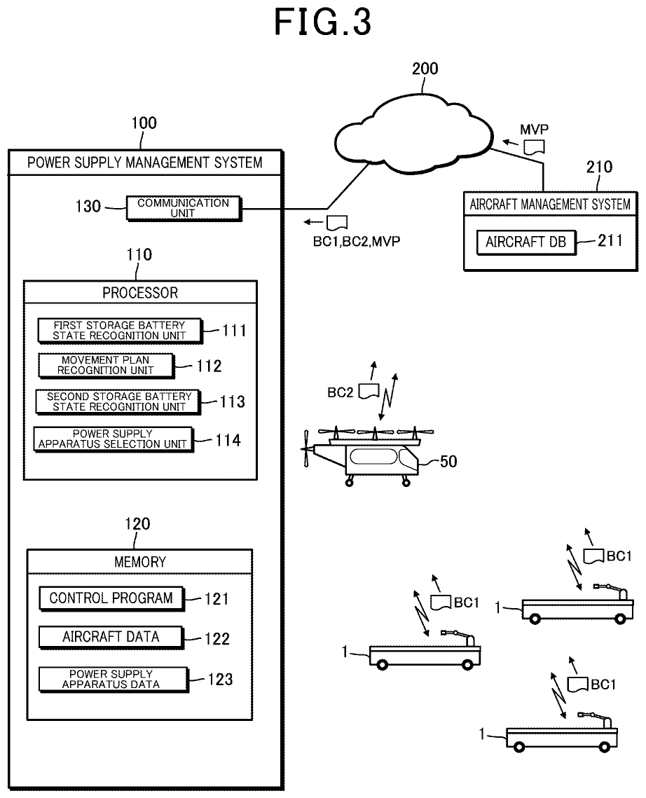

The configuration of the power supply management system 100 will be described with reference to FIGS. 2 and 3. The power supply management system 100 is configured with a computer and manages operation of a plurality of power supply apparatuses 1. FIG. 2 shows a state in which: the power supply management system 100 selects one power supply apparatus 1 from among a plurality of power supply apparatuses 1; and causes an aircraft 50 that is to be moved (hereinafter referred to as a target aircraft 50) to be placed and moved.

In FIG. 2, the selected power supply apparatus 1 is loaded with the target aircraft 50 in the hangar area Ar1, and moves it to a departure and arrival area Ar3 via a parking area Ar2. The hangar area Ar1, the parking area Ar2, and the departure and arrival area Ar3 correspond to predetermined points and movement points of the present disclosure. The hangar area Ar1 corresponds to a first point of the present disclosure, and the departure and arrival area Ar3 corresponds to a second point of the present disclosure.

The power supply management system 100 communicates with an aircraft management system 210, a plurality of the power supply apparatuses 1, and the aircraft 50 via a communication network 200. The aircraft management system 210 is configured with a computer including a processor, a memory, a communication unit (transmitter and receiver) or the like in which movement plans for a plurality of aircrafts are recorded.

The power supply management system 100 accesses an aircraft DB 211 of the aircraft management system 210 and acquires movement plan information MVP indicating the movement plan of the target aircraft 50. In addition, the power supply management system 100 receives: the first storage battery state information BC1 indicating the states of the first storage batteries 11, which are transmitted from the individual power supply apparatuses 1; and the second storage battery state information BC2 indicating the state of the second storage battery 52, which is transmitted from the aircraft 50.

The power supply management system 100 determines the power supply apparatus 1 to be selected, based on: the movement plan of the aircraft 50 recognized from the movement plan information MVP; the state of the first storage battery 11 recognized from the first storage battery state information BC1; and the state of the second storage battery 52 recognized from the second storage battery state information BC2.

With reference to FIG. 3, the power supply management system 100 is a computer system including processor 110, a memory 120, a communication unit 130 (transmitter and receiver) or the like. The communication unit 130 communicates with the aircraft management system 210, the aircraft 50, and a plurality of the power supply apparatuses 1 via the communication network 200.

The memory 120 stores: a control program 121 of the power supply management system 100; movement plan information MVP; aircraft data 122 in which information related to the aircraft 50 such as the second storage battery state information BC2 is recorded; and power supply apparatus data 123 in which information related to the power supply apparatus 1 such as the first storage battery state information BC1 is recorded.

By reading and executing the control program 121, the processor 110 functions as a first storage battery state recognition unit 111, a movement plan recognition unit 112, a second storage battery state recognition unit 113, and a power supply apparatus selection unit 114.

The first storage battery state recognition unit 111 receives the first storage battery state information BC1 transmitted from the power supply apparatus 1 using the communication unit 130, and individually recognizes the states of the first storage batteries 11 of the power supply apparatuses 1. The first storage battery state recognition unit 111 records the first storage battery state information BC1 in the power supply apparatus data 123.

The movement plan recognition unit 112 accesses the aircraft DB 211 of the aircraft management system 210, acquires the movement plan information MVP of the aircraft 50, and recognizes the movement plan of the aircraft 50 from the movement plan information MVP. The movement plan recognition unit 112 records the movement plan information MVP in the aircraft data 122. The second storage battery state recognition unit 113 receives the second storage battery state information BC2 transmitted from the aircraft 50 using the communication unit 130, and recognizes the state of the second storage battery 52 of the aircraft 50. The second storage battery state recognition unit 113 records the second storage battery state information BC2 in the aircraft data 122.

The power supply apparatus selection unit 114 selects a power supply apparatus 1 that satisfies the following conditions from among a plurality of the power supply apparatuses 1.

First condition: being capable of supplying the aircraft 50 with the second power corresponding to the power amount A that is a power amount required to charge the second storage battery 52 up to the electricity storage amount that covers the power amount consumed when the aircraft 50 executes a flight according to the movement plan. For example, if the aircraft flies only with the power of the storage battery 52, the “power amount consumed when the aircraft 50 executes the flight according to the movement plan” is the power amount required to execute the movement plan from the departure location to the destination.

Second condition: being capable of supplying the traveling unit 16 with the first power corresponding to the power amount B, which is a power amount required for traveling from the hangar area Ar1 to the departure and arrival area Ar3 while the aircraft 50 is placed thereon. The “power amount required for traveling from the hangar area Ar1 to the departure and arrival area Ar3” is, for example, the power amount calculated from the moving distance from Ar1 to Ar3 and an electric mileage (travel distance per predetermined power) of the power supply apparatus 1 in which the calculation of the electric mileage takes the weight of the placed aircraft 50 into account.

### [3. Selection Processing of Power Supply Apparatus by Power Supply Management System]

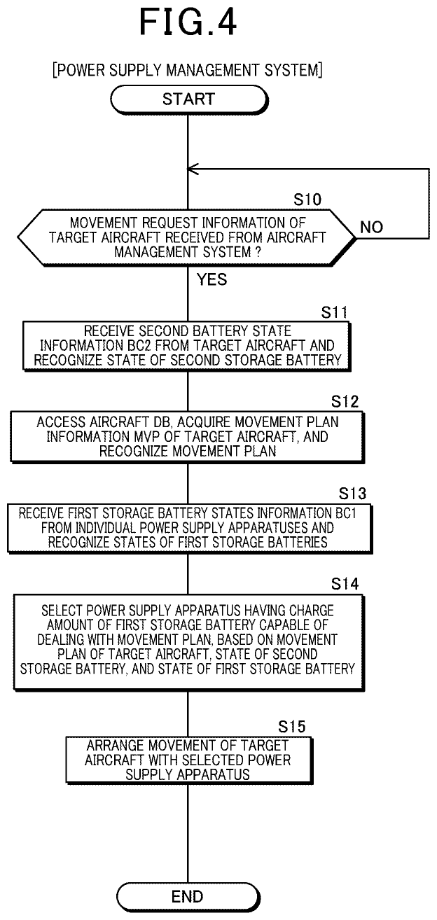

The following will describe a procedure for selection processing of the power supply apparatus 1 executed by the power supply management system 100 in the situation shown in FIG. 2 according to the flowchart shown in FIG. 4.

In step S10 of FIG. 4, when the power supply apparatus selection unit 114 receives movement request information, requesting movement of the target aircraft 50, being transmitted from the aircraft management system 210, the power supply apparatus selection unit 114 advances processing to step S11. In step S11, the second storage battery state recognition unit 113 receives the second storage battery state information BC2 from the target aircraft 50, and recognizes the state of the second storage battery 52 of the target aircraft 50 (electricity storage amount, temperature, etc.) from the second storage battery state information BC2.

In subsequent step S12, the movement plan recognition unit 112 accesses the aircraft DB 211 of the aircraft management system 210, acquires the movement plan information MVP of the target aircraft 50, and recognizes the movement plan of the target aircraft 50 from the movement plan information MVP. In the next step S13, the first storage battery state recognition unit 111 receives the first storage battery state information BC1 from a plurality of the waiting power supply apparatuses 1, and individually recognizes the states (electricity storage amount, temperature, etc.) of the first storage batteries 11 of individual power supply apparatuses 1 from the first storage battery state information BC1. In the next step S14, the power supply apparatus selection unit 114 selects a power supply apparatus 1 that satisfies the above first and second conditions, based on the movement plan of the target aircraft 50, the state of the second storage battery 52 of the target aircraft 50, and the states of the first storage batteries 11 of the individual power supply apparatuses 1. Furthermore, the power supply apparatus selection unit 114 may select a power supply apparatus 1 in which: the power amount C that can be supplied from the first storage battery 11 mounted is greater than the total value of the power amount A under the first condition and the power amount B under the second condition (power amount C>power amount A+power amount B); and the electricity storage amount in the first storage battery 11 has a margin.

In subsequent step S15, the power supply apparatus selection unit 114 transmits movement instruction information instructing the movement of the target aircraft 50 to the selected power supply apparatus 1, and arranges movement of the target aircraft 50. As a result, as shown in FIG. 2, the selected power supply apparatus 1 supplies power to the target aircraft 50 placed thereon, while traveling from the hangar area Ar1 to the departure and arrival area Ar3 via the parking area Ar2.

### [4. Control Processing of Power Supply by Power Supply Apparatus]

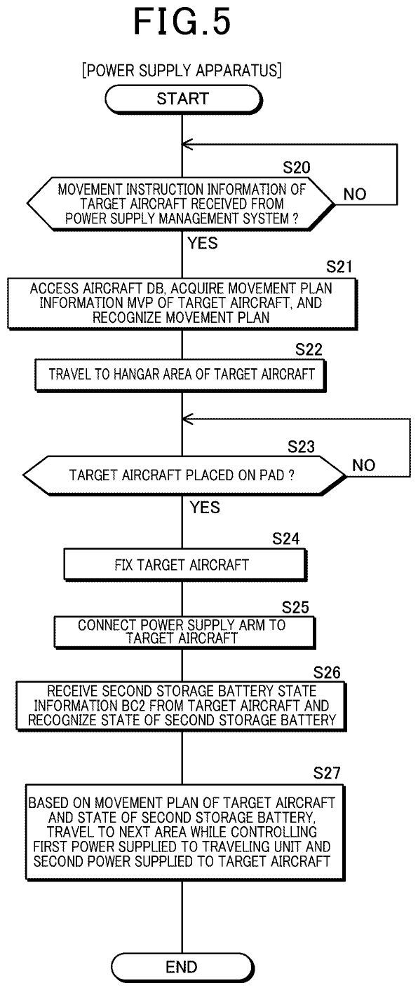

A procedure of control processing of power supply executed by the power supply apparatus 1 will be described according to the flowchart shown in FIG. 5.

In step S20 of FIG. 5, upon receipt of movement instruction information for the target aircraft 50 from the power supply management system 100, the power supply control unit 24 advances processing to step S21. In step S21, the movement plan recognition unit 21 accesses the aircraft DB 211 of the aircraft management system 210, acquires the movement plan information MVP of the target aircraft 50, and recognizes the movement plan of the target aircraft 50 from the movement plan information MVP.

In the subsequent step S22, the travel control unit 25 automatically travels to the hangar area Ar1 where the target aircraft 50 waits. In the next step S23, when it is recognized that the target aircraft 50 has been placed on the pad through communication with the target aircraft 50 or the like, the travel control unit 25 advances processing to step S24, and fixes the target aircraft 50 to the pad 40 with fixtures 42 (see FIG. 1).

In the next step S25, the power supply control unit 24 connects the power supply arm 41 to the charging port 51 of the target aircraft 50. In subsequent step S26, the second storage battery state recognition unit 23 receives the second storage battery state information BC2 from the aircraft 50, and recognizes the state (electricity storage amount, temperature, etc.) of the second storage battery 52 from the second storage battery state information BC2.

In subsequent step S27, the power supply control unit 24 causes the power supply apparatus 1 to travel to the next areas (in FIG. 2, the aircraft parking area Ar2 and the departure and arrival area Ar3) while controlling the first electric power supplied to the traveling unit 16 and the second electric power supplied to the target aircraft 50, based on the movement plan of the target aircraft 50 and the state of the second storage battery 52 of the target aircraft 50.

### 5. Other Embodiments

FIG. 2 shows an example in which the power supply apparatus 1 is selected for one target aircraft 50 to move the target aircraft 50. On the other hand, in a case in which there are a plurality of target aircrafts 50, one power supply apparatus 1 is similarly selected by the power supply management system 100 for each target aircraft 50 to move each target aircraft 50.

In the above embodiment, the second storage battery 52 mounted on the aircraft 50 is charged with the power supplied from the power supply apparatus 1 to the aircraft 50. As another embodiment, electric power may be supplied from the power supply apparatus 1 to the aircraft 50 in order to operate the storage battery temperature adjustment unit 53 without charging the second storage battery 52. In this case, for example, the power amount D that needs to be supplied from the power supply apparatus 1 to the aircraft 50 is calculated through the following procedures (1) to (5).
(1) Acquire information on the temperature state of the second storage battery 52.
(2) Acquire information on the target temperature (for example, 25)C.° of the second storage battery 52. A target temperature may be set in advance.
(3) Acquire information on the outside temperature (measured temperature or expected temperature, for example, 0)C°.
(4) From the movement plan of the aircraft 50, acquire information on a time (for example, 5 hours) during which the temperature control of the second storage battery 52 is required in the period until the scheduled departure time of the aircraft 50.
(5) Based on the information acquired in (1) to (4) above, calculate the power amount D required to control the temperature of the second storage battery 52 to the target temperature by the scheduled departure time.

Note that FIGS. 1 and 3 are schematic diagrams showing functional configurations of the power supply apparatus 1 and the power supply management system 100, each divided according to what are mainly processed, to facilitate understanding of the present invention. So, the configurations of the power supply apparatus 1 and the power supply management system 100 may be made with another division. Further, the processing of each component may be executed by one hardware unit, or may be executed by a plurality of hardware units. Also, the processing with each component shown in FIGS. 4 and 5 may be executed by one program or may be executed by a plurality of programs.

### [6. Configurations Supported by the Above Embodiments]

The above embodiments are specific examples of the following configurations.

### (Configuration 1)

A power supply apparatus including: a first storage battery; a traveling unit operated and caused to travel by electric power supplied from the first storage battery; a pad, mounted on the traveling unit, on which a vertical take-off and landing aircraft is placed; a power supply unit for supplying the aircraft placed on the pad with power output from the first storage battery; a movement plan recognition unit for recognizing a movement plan of the aircraft; a second storage battery state recognition unit for recognizing a state of a second storage battery provided in the aircraft; and a power supply control unit for controlling first power and second power via the power supply unit, based on the movement plan recognized by the movement plan recognition unit and the state of the second storage battery recognized by the second storage battery state recognition unit, the first power being supplied from the first storage battery to the traveling unit, the second power being supplied from the first storage battery to the aircraft via the power supply unit.

The power supply apparatus of configuration 1 makes it possible to efficiently charge the second storage battery by supplying power to the aircraft while traveling with the aircraft placed on the pad.

### (Configuration 2)

The power supply apparatus according to configuration 1, wherein the power supply control unit determines a supply amount of the first power, based on power required for moving by using the traveling unit while the aircraft is placed on the pad, between predetermined points by a time of next flight of the aircraft.

The power supply apparatus of configuration 2 makes it possible to determine the supply amount of the first power so as to reliably provide the power required for movement between predetermined points.

### (Configuration 3)

The power supply apparatus according to configuration 1 or 2, wherein the power supply control unit determines a supply amount of the second power, based on power required for charging a second storage battery and power required for operating a storage battery temperature adjustment unit, the second storage battery being provided in the aircraft, the storage battery temperature adjustment unit being provided in the aircraft, the storage battery temperature adjustment unit heating or cooling the second storage battery.

The power supply apparatus of configuration 3 makes it possible to determine the supply amount of the second power so as to reliably provide the power required for charging the second storage battery provided in the aircraft and for operating the storage battery temperature adjustment unit.

### (Configuration 4)

The power supply apparatus according to any one of configurations 1 to 3, wherein the movement plan includes a departure time, a departure location, an arrival time, an arrival location, and movement points on ground.

The power supply apparatus of configuration 4 makes it possible to control the first power supplied from the first storage battery to the traveling unit and the second power supplied from the first storage battery to the aircraft via the power supply unit, based on the information about moving on the ground while the aircraft is placed on the power supply apparatus as well as the information needed for flight planning of the aircraft.

### (Configuration 5)

A power supply management system for managing operation of a power supply apparatus including: a first storage battery; a traveling unit operated and caused to travel by electric power supplied from the first storage battery; a pad, mounted on the traveling unit, on which a vertical take-off and landing aircraft is placed; and a power supply unit for supplying the aircraft placed on the pad with power output from the first storage battery, the power supply management system including: a first storage battery state recognition unit that individually recognizes states of the first storage batteries for a plurality of the power supply apparatuses; a movement plan recognition unit for recognizing a movement plan of a target aircraft, the target aircraft being the aircraft parked at a first point; a second storage battery state recognition unit for recognizing a state of a second storage battery provided in the target aircraft; and a power supply apparatus selection unit for selecting the power supply apparatus that is to travel to a second point while the target aircraft is placed on the pad, based on: states of the first storage batteries of a plurality of the power supply apparatuses; the movement plan recognized by the movement plan recognition unit; and the state of the second storage battery, the states of the first storage batteries being recognized by the first storage battery state recognition unit, the state of the second storage battery being recognized by the second storage battery state recognition unit.

The power supply management system of configuration 5 makes it possible to select a power supply apparatus that can supply power to the target aircraft and supply power to the traveling unit according to the movement plan of the target aircraft, and to efficiently charges the second storage battery of the target aircraft while the target aircraft is placed on the selected power supply apparatus and moved.

### REFERENCE SIGNS LIST

1 . . . power supply apparatus, 10 . . . truck unit, 11 . . . first storage battery, 12 . . . storage battery temperature adjustment unit, 13 . . . storage battery sensor, 14 . . . power supply unit, 15 . . . communication unit, 16 . . . traveling unit, 17 . . . control unit, 18 . . . charging port, 20 . . . processor, 21 . . . movement plan recognition unit, 22 . . . first storage battery state recognition unit, 23 . . . second storage battery state recognition unit, 24 . . . power supply control unit, 25 . . . travel control unit, 31 . . . control program, 32 . . . movement plan data, 40 . . . pad, 50 . . . aircraft, 51 . . . charging port, 52 . . . second storage battery, 53 . . . storage battery temperature adjustment unit, 54 . . . storage battery sensor, 55 . . . control unit, 56 . . . communication unit, 57 . . . rotor, 100 . . . power supply management system, 110 . . . processor, 111 . . . first storage battery state recognition unit, 112 . . . movement plan recognition unit, 113 . . . second storage battery state recognition unit, 114 . . . power supply apparatus selection unit, 120 . . . memory, 121 . . . control program, 122 . . . aircraft data, 123 . . . power supply apparatus data 130 . . . communication unit, 200 . . . communication network, 210 . . . aircraft management system, 211 . . . aircraft DB.

What is claimed is:

1. A power supply apparatus comprising:
a first storage battery;
a traveling unit operated and caused to travel by electric power supplied from the first storage battery;
a pad, mounted on the traveling unit, on which a vertical take-off and landing aircraft is placed;
a power supply unit for supplying the aircraft placed on the pad with power output from the first storage battery;
a movement plan recognition unit for recognizing a movement plan of the aircraft;
a second storage battery state recognition unit for recognizing a state of a second storage battery provided in the aircraft; and
a power supply control unit for controlling first power and second power via the power supply unit, based on the movement plan recognized by the movement plan recognition unit and the state of the second storage battery recognized by the second storage battery state recognition unit, the first power being supplied from the first storage battery to the traveling unit, the second power being supplied from the first storage battery to the aircraft via the power supply unit.

2. The power supply apparatus according to claim 1, wherein
the power supply control unit determines a supply amount of the first power, based on power required for moving by using the traveling unit while the aircraft is placed on the pad, between predetermined points by a time of next flight of the aircraft.

3. The power supply apparatus according to claim 1, wherein
the power supply control unit determines a supply amount of the second power, based on power required for charging a second storage battery and power required for operating a storage battery temperature adjustment unit, the second storage battery being provided in the aircraft, the storage battery temperature adjustment unit being provided in the aircraft, the storage battery temperature adjustment unit heating or cooling the second storage battery.

4. The power supply apparatus according to claim 1, wherein
the movement plan includes a departure time, a departure location, an arrival time, an arrival location, and movement points on ground.

5. A power supply management system for managing operation of a power supply apparatus including:
a first storage battery;
a traveling unit operated and caused to travel by electric power supplied from the first storage battery;
a pad, mounted on the traveling unit, on which a vertical take-off and landing aircraft is placed; and
a power supply unit for supplying the aircraft placed on the pad with power output from the first storage battery,
the power supply management system comprising:
a first storage battery state recognition unit that individually recognizes states of the first storage batteries for a plurality of the power supply apparatuses;
a movement plan recognition unit for recognizing a movement plan of a target aircraft, the target aircraft being the aircraft parked at a first point;
a second storage battery state recognition unit for recognizing a state of a second storage battery provided in the target aircraft; and
a power supply apparatus selection unit for selecting the power supply apparatus that is to travel to a second point while the target aircraft is placed on the pad, based on: states of the first storage batteries of a plurality of the power supply apparatuses; the movement plan recognized by the movement plan recognition unit; and a state of the second storage battery, the states of the first storage batteries being recognized by the first storage battery state recognition unit, the state of the second storage battery being recognized by the second storage battery state recognition unit.
